(19) United States
(12) Patent Application Publication
(10) Pub. No.: US 2011/0091787 A1
(43) Pub. Date: Apr. 21, 2011

(54) COMPOSITIONS OF NANOMETAL PARTICLES CONTAINING A METAL OR ALLOY AND PLATINUM PARTICLES FOR USE IN FUEL CELLS

(75) Inventors: Kimberly McGrath, Newport Beach, CA (US); Douglas Carpenter, Tustin, CA (US)

(73) Assignee: QUANTUMSPHERE, INC., Santa Ana, CA (US)

(21) Appl. No.: 12/964,570

(22) Filed: Dec. 9, 2010

Related U.S. Application Data
(63) Continuation of application No. 11/394,456, filed on Mar. 31, 2006, now abandoned.

(51) Int. Cl. H01M 8/10; H01M 4/38

(52) U.S. Cl. 429/479; 429/524

(57) ABSTRACT

A composition of nanoparticles of metal or an alloy or having a metal and alloy core with an oxide shell in admixture with platinum particles is useful as a component for electrodes. More particularly, such composition is useful as an electrode ink for the reduction of oxygen as well as the oxidation of hydrocarbon or hydrogen fuel in a direct oxidation fuel cell, such as, but not limited to, the direct methanol fuel cell. These electrodes encompass a catalyst ink containing platinum, the nanoparticles, and a conducting ionomer which may be directly applied to a conductive support, such as woven carbon paper or cloth. This electrode may be directly adhered onto an ion exchange membrane. The nanoparticles comprise nanometer-sized transition metals such as cobalt, iron, nickel, ruthenium, chromium, palladium, silver, gold, and copper. In this invention, these catalytic powders substantially replace platinum as a catalyst in fuel cell electrooxidation and electroreduction reactions.

### PRIORITY

This application is a continuation of U.S. patent application Ser. No. 11/394,456, filed Mar. 31, 2006, the entire contents of which are incorporated herein by reference.

### TECHNICAL FIELD

The present invention relates to compositions comprising nanoparticles of a metal and/or alloy or nanoparticles comprising a metal or alloy core surrounded by an oxide shell in admixture with platinum particles. More particularly, the composition is useful for inks used to make anode and cathode electrodes, which may be used in fuel cells.

### BACKGROUND ART

Platinum is highly catalytic for hydrocarbon or hydrogen oxidation and oxygen reduction in gas diffusion electrodes for a variety of fuel cells. However, this noble metal is a rapidly depleting non-renewable resource and is consequently expensive. Current price for bulk platinum black is $75.00/gram. The associated cost of a platinum deposited electrode, typically loaded anywhere from 2-8 mg/cm², is widely considered to be a hurdle to widespread commercialization. With the gaining demand for alternative energy sources by consumers, efficient catalysts, especially at practical operating temperature (room temperature to 60° C.) must be discovered to alleviate the demand and expense of platinum. Based on this, considerable effort is being dedicated to find an alternative catalyst which can match or exceed platinum's electrical performance. Method of synthesis of metal nanoparticles has been previously described in U.S. patent application Ser. No. 10/840,409, as well as their use in air cathodes for batteries in U.S. patent application Ser. No. 10/983,993 both of which applications have the same assignee as the present application. The disclosures of these applications are incorporated herein by reference. Platinum particles have also been prepared for fuel cell electrodes by chemical reduction on carbon.

### DISCLOSURE OF THE INVENTION

Nanoparticle catalysts can be used to supplement platinum catalysts for fuel cell electrodes embodiments of the invention. Embodiments include nanoparticle catalysts of cobalt, iron, nickel, ruthenium, chromium, palladium, silver, gold, and copper and their alloys that are at least nearly as active as platinum for the reduction of oxygen or oxidation of hydrocarbon fuel in direct oxidation fuel cells. Various embodiments described herein discuss metal nanoparticle catalysts for direct methanol fuel cell applications, but are equally applicable to other applications, for example without exclusion (i) proton exchange membrane fuel cells (PEMFC's), and formic acid fuel cells (FAFC's).

A first embodiment includes nanoparticles, which can comprise a single metal or an alloy of two or more transition metals, optionally having an oxide shell surrounding the metal or alloy core admixed or physically blended with platinum particles. Preferably, these platinum particles are under one micron in size, which are classified as finely divided. Preferably, the platinum particles should be below 100 nm in diameter.

Preferably, nanoparticles have a diameter less than 50 nm, and preferably under 30 nm. Ideally, these particles should be less than 15 nm in diameter to maximize the surface interaction with platinum.

In another embodiment, the transition metals cobalt, iron, nickel, ruthenium, chromium, palladium, silver, gold and copper or alloys thereof comprise the nanoparticles or core, if an oxide shell is present. Although not being bound by theory, these elements accept electrons from platinum, which is preferable to observe the enhanced catalysis. Alloy nanoparticles preferably comprise two or more transition metals, or has two, three or four. The transition metals specified previously can be prepared in a variety of ratios to yield performance enhancement. The application in which the electrodes are used will dictate the alloy composition. In one embodiment, one metal of the alloy can range anywhere from 5 to 95% by weight of the alloy. In one embodiment, one metal of the alloy is greater than 10% by weight, or greater than 25%. In one embodiment, one metal is 90% by weight of the alloy.

In the composition, the nanoparticles are 5% or more by weight of the nanoparticles and platinum particles combined. In another embodiment, nanoparticles are 25% or more by weight of the nanoparticles and platinum particles, or 50% or more by weight.

Preferably, at least 50% of the platinum by total metal weight of conventional compositions is replaced with metal nanoparticles or metal alloy nanoparticles. The nanoparticles may also be 75% or more by weight or 90% or more by weight.

In another embodiment, the platinum/nanoparticle admix is combined with an ionomer, in many cases, a proton conducting ionomer, to promote ionic conductivity and to bind the electrode to a conducting membrane. This ionomer may be combined with the platinum-nanometal mixture and can be up to 40% by weight of the total platinum and nanometal weight. The combination of platinum, nanometal particle, and ionomer forms an ink. Preferably, the ionomer is a perfluorinated resin, which has both hydrophobic and hydrophilic properties. More preferably the perfluorinated resin is a conducting polymer.

The ink composition may be used with an electron-conducting support to form an electrode. In one embodiment, this ink is applied to an electrically conductive carbon substrate. The electron-conducting support may also be carbon paper, cloth, or powder. The ink composition may be applied to the electron-conducting support by painting, screen printing, or spraying. The electrode subsequently may be applied to an ion-exchange membrane and used in a direct oxidation fuel cell. This fuel cell is capable of converting chemical energy directly to electrical energy.

### BRIEF DESCRIPTION OF THE DRAWINGS

FIG. 1 is a transmission electron micrograph of cobalt metal nanoparticles.

FIG. 2 is a transmission electron micrograph of cobalt-nickel alloy nanoparticles.

FIG. 3 details the cross-section of a direct oxidation fuel cell anode or cathode electrode.

FIG. 4 shows a drawing of a direct methanol fuel cell.

FIG. 5 shows a voltammogram of cathode electrode performance.

FIG. 6 shows a voltammogram of cathode electrode performance.

### MODES OF CARRYING OUT THE INVENTION

The inclusion of nanoparticles of metal, alloy and/or either having an oxide shell in the ink composition serves to improve the efficiency of oxidation and reduction reactions by increasing the reaction surface area as well as enhancing electrocatalysis. The observed electrocatalysis enhancement can be explained by molecular orbital theory. Since the nanoparticles are in good contact with platinum, they accept electrons from platinum. In turn, platinum becomes electron deficient, and will react faster with the oxidant and reductant, thereby increasing the efficiency of the reaction.

Due to increased surface area, when nanoparticles are blended with platinum, water, and an ionically conducting polymer to form an ink, the activity of platinum is increased due to enhanced contact of the platinum and the nanoparticles. This contact serves two main functions, a) to enhance the electronic interaction of platinum with the oxidant or reductant by virtue of increasing the d-orbital vacancy on Pt by the nanoparticles, and b) to efficiently disperse Pt throughout the ink so that it has improved contact with the oxidant and/or reductant. Additionally, metal alloy nanoparticles also provide these benefits. A metal alloy nanoparticle is a compound which has individual metal components combined in such a way such that combination gives the compound unique chemical structure and properties in each individual particle.

In this catalytic ink formula, the platinum particles should preferably be small enough such that they can have strong surface interactions with the nanoparticles. Preferably, the platinum should be finely divided. Platinum is considered to be finely divided when the particle size is below a micron, preferably below 500 nm in diameter such as from 1-500 nm. Although finely divided platinum particles are adequate, it is preferred that the platinum particles have a diameter below 100 nm to maximize the platinum-nanoparticle surface contact. Preferred diameter of platinum particles are 1-100 nm, more preferably from 5-50 nm, most preferably from 5-25 nm.

Nanoparticles as used herein refer to metal nanoparticles, metal alloy nanoparticles, or nanoparticles of metal or alloy having an oxide shell or mixtures thereof. Additionally, the individual nanoparticles should preferably have a diameter below 50 nm, and preferably below 15 nm such as from 1-15 nm. In initial studies, it was found that particles at the micron level do not exhibit the catalytic enhancing effect that the nanoparticles show. In studies using micron sized-metals and platinum in the ink, a decrease in performance was observed due to lower surface area. Further the micron particles fall out of the electrode, and ultimately lead to electrode failure. Thus, the high surface area nanoparticles are necessary for proper electronic interaction and dispersion with platinum.

In addition, it is preferable that the metal or alloy nanoparticles have an oxide shell or outer surface, with a shell thickness of 1-25 nm, most preferably in the 1-10 nm range. These particles can be produced by vapor condensation in a vacuum chamber, and oxide thickness can be controlled by introduction of air or oxygen into the chamber as the particles are formed.

The nanoparticles that can be used in the ink may comprise a variety of the d-block transition metals, including cobalt, iron, nickel, ruthenium, chromium, palladium, silver, gold, and copper or mixtures thereof. Platinum is known to donate its electrons to these elements, thereby making platinum more reactive to the fuel.

Additionally, the nanoparticles can comprise two or more individual metals, which form a metal alloy nanoparticle. The individual metals of the alloy can be combined in any ratio ranging from 5-95%. The ratio of the metals used in each particular alloy for the ink largely depends on the catalytic application. The metal alloy nanoparticles represented here can be two or more of the following transition metals cobalt, iron, nickel, ruthenium, chromium, palladium, silver, gold, and copper. For example, in a nickel/cobalt nano-alloy used in an electrode for a fuel cell operating at room temperature requires a higher content of cobalt in the alloy. For a room temperature direct methanol fuel cell, a 50:50 60:40, 70:30, and 80:20 wt % ratio nanometal alloy of cobalt and nickel showed the largest increase in electrical performance, because it efficiently accepts electrons from platinum. However, other ratios also work efficiently in conjunction with platinum. For a cathode electrode, a 50:50, 60:40, 70:30, and 80:20 wt % nanometal alloy of cobalt and silver or cobalt and gold gives excellent electrical performance because the silver or gold component imparts increased methanol tolerance while the cobalt component improves oxygen reduction kinetics. Other ratios also work efficiently in conjunction with platinum. When palladium is alloyed with cobalt, nickel, iron, or silver in 50:50, 60:40, 70:30, and 80:20 wt % ratios, catalytic enhancement is observed compared to pure platinum for oxygen reduction. In higher temperature fuel cells, such as the hydrogen PEM fuel cell, an 20:80 wt % ratio of cobalt to nickel is preferred, which imparts greater stability due to the increased nickel content. However, other ratios also work efficiently in conjunction with platinum. As an anode electrode, a 33:33:34 wt percent ratio of chromium:ruthenium:platinum works to enhance the kinetic of methanol oxidation. In addition, a 50:50 chromium-ruthenium alloy used in 60 wt % ratio and 40 wt % ratio also shows performance higher than traditional anode electrodes.

Along with platinum and the nanoparticles, an ink or catalyst ink contains an ionomer which enhances physical contact between the electrode and the fuel cell membrane, and also promotes ionic conductivity at the electrode-membrane interface. The most common type of fuel cell membrane is the proton exchange membrane, in which case the ionomer is proton conducting.

Preferably, the ink contains enough of the ionomer such that adhesion to the membrane and ionic conductivity are enhanced, likewise, it is preferred that the ionomer not be in excess of 40% by weight of the total ink. Preferably, the ionomer is present from 5-40% by weight of total metal loading, more preferably 10-30% and most preferably 15-25%. “Total metal loading” is total amount of metal in the ink. At high concentrations of ionomer, a large resistance builds in the electrode, and blocks electrons from efficiently moving through the external circuit of the fuel cell.

The ratio of platinum to the nanoparticles will largely depend on the mode of fuel cell operation. The catalyst blend is very sensitive to oxidant and reductant concentration and temperature. Due to the high cost of platinum, high nanoparticle fractions are ideal. A minimum of 5% nanoparticles (i.e., without platinum) by weight of total metal content is preferred to observe increased catalytic activity, however over 90% of platinum by weight of conventional compositions can be replaced with the nanoparticles. Most preferably, 50 to 75% of platinum particles are replaced by metal and/or alloy nanoparticles.

In a direct oxidation fuel cell, such as the methanol fuel cell, the ionomer conducts protons. A typical ionomer used in the ink is Nafion®, a perfluorinated ion exchange polymer. The polymer resin contains both hydrophilic and hydrophobic domains such that there is a balance of both water-rejecting and water accepting properties. Although water provides improved proton conduction, an excess of water blocks catalyst sites from the oxidant and reductant, thereby lowering fuel cell efficiency.

The ink composition is prepared by mixing dry platinum and dry nanoparticles in any ratio, such as those specified above. Preferably, several drops of water are added to the mixture to minimize the risk of fire. Finally, the ionomer of specified amount is added, and the resulting ink is blended, for example, on a vortex mixer and sonicated, for example, for several minutes. The electrode is prepared by depositing the ink on a conductive support. The conductive support conducts electrons from the membrane-electrode interface to the fuel cell external circuit.

The ink is usually applied to the electron-conducting support by direct painting, spraying, or screen printing. The method chosen is not critical to electrode performance in the fuel cell, however the method should preferably ensure an even coating of ink across an entire surface of the electrode.

The ideal material to use for the electron conducting support is carbon, however other electronically conducting materials can also work. Woven carbon paper or fabric serves to support the ink, conduct electrons, and allow for the influx of oxidant and reductant by virtue of its porous nature.

In a direct oxidation fuel cell, the electrodes can be thermally pressed to either side of an ion conducting membrane. In the case of the direct methanol fuel cell, the electrodes can be applied onto a proton conducting polymer, for example by hot pressing, and subsequently placed in contact with bipolar plates that efficiently conduct electrons.

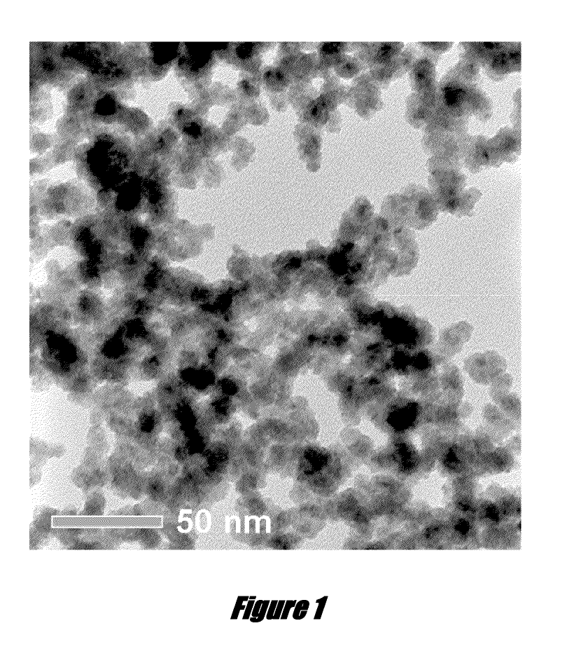

In the experiments below as presented by the data in FIGS. 1-6, the nanoparticles used have a metal core as indicated and have an oxide shell. The name of the metal without reference to the oxide shell is used for simplicity.

FIG. 1 shows a transmission electron micrograph image of nano-sized cobalt particles that can be used in the ink. The average size of these particles are 8 nm, and their surface can come in excellent contact with finely divided platinum. The level of contact between the platinum and metal nanoparticles is directly quantified by the increase in catalytic enhancement observed from the oxidant/reductant reaction on the surface of the electrode.

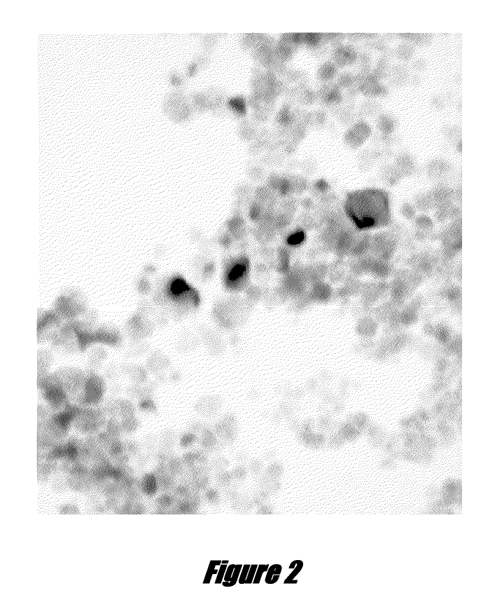

FIG. 2 shows a transmission electron micrograph image of nano-sized nickel-cobalt alloy nanoparticles that can be used in the ink. The average size of these particles is 12 nm, and their surface can come in excellent contact with finely divided platinum. The level of contact between the platinum and nanoparticles is directly quantified by the increase in catalytic enhancement observed form the oxidant/reductant reaction on the surface of the electrode.

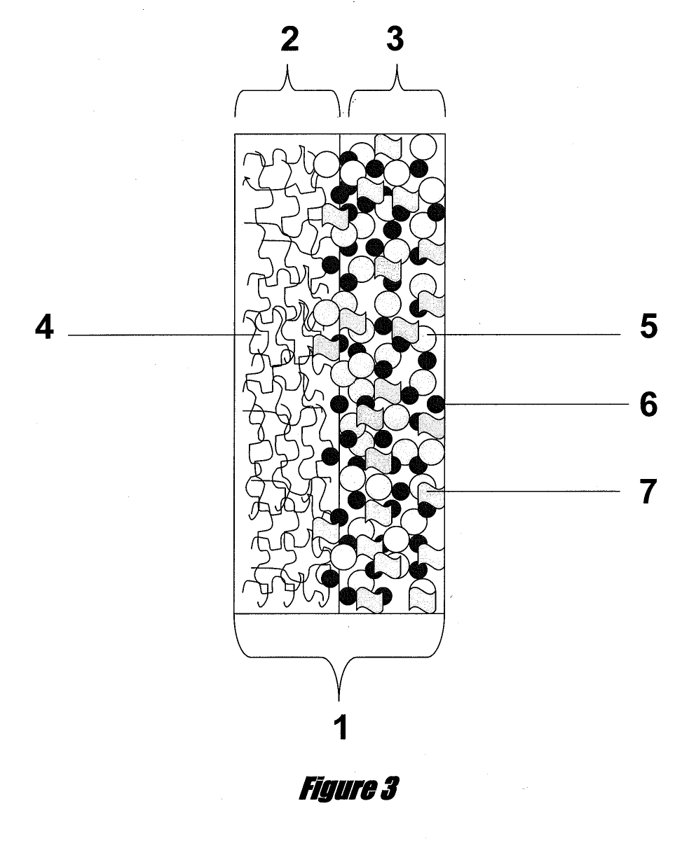

FIG. 3 depicts the cross section of the fuel cell electrode (1). The catalyst ink (3) and the electron-conducting support (2) composed of carbon fibers (4). In the ink layer, platinum (5) and the nanoparticles (6) are in intimate contact with one another, and supported inside the ionomer (7).

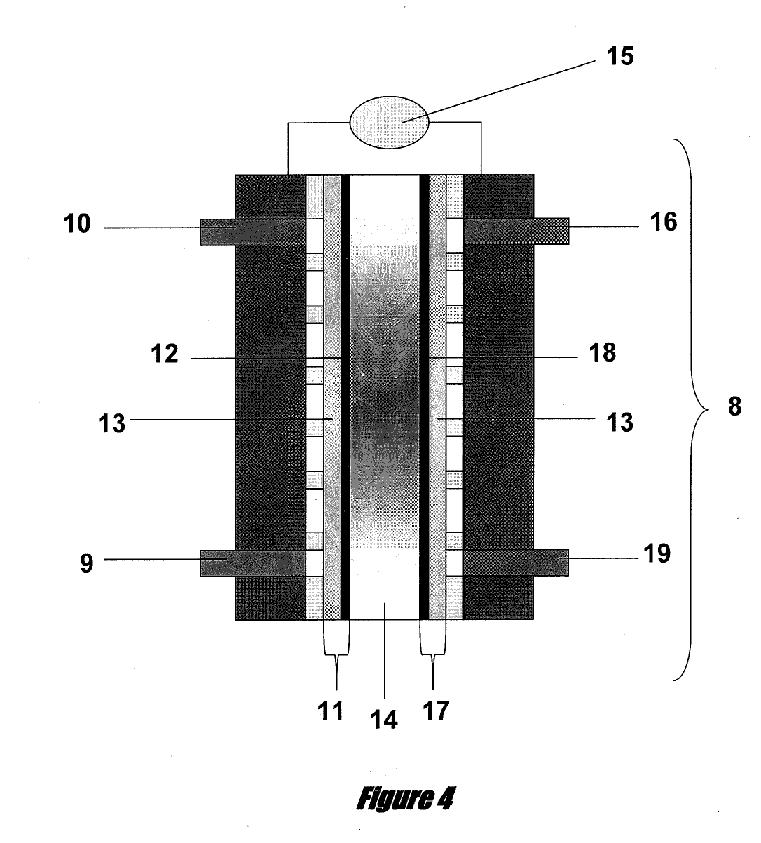

FIG. 4 depicts a direct methanol fuel cell (8). Aqueous methanol is fed into the anode port (9), where it is circulated through port (10) or remains inside the cell. The methanol reacts at the anode electrode (11) (encompassing the ink (12) and the electron-conducting support (13)) to produce carbon dioxide, protons, and electrons. Protons pass through the proton exchange membrane (14) to the cathode compartment, and electrons flow through the external circuit (15) and into the cathode. Air is fed into the cathode port (16), where it reacts with electrons and protons produced from the anode on the cathode electrode (17) (encompassing the ink (18) and electron-conducting support (13)) to produce water, which is removed at the other cathode port (19).

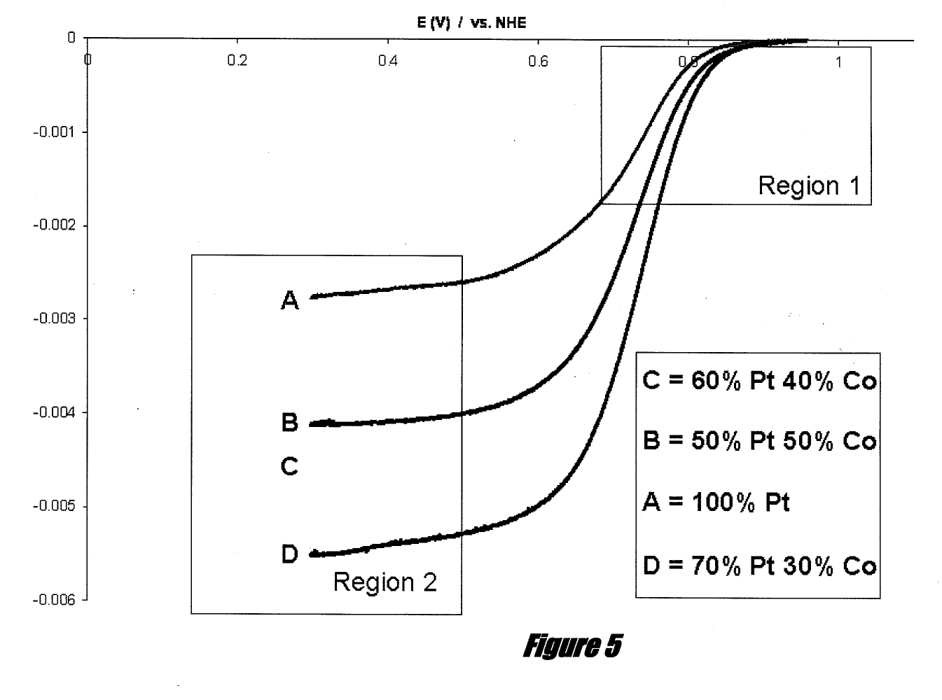

As one example, FIG. 5 data shows a linear sweep voltammogram of the fuel cell cathode reaction, which depicts how current density, j, increases as voltage, V, decreases. The total metal loading in each ink sample is 8 mg/cm². The greater the magnitude of the current increases as voltage decreases, the better the performance of the catalyst ink. Curve A represents a fuel cell cathode catalyst ink containing finely divided platinum and no nanoparticles. Curves B-D show the increased performance by removing some of the platinum and replacing it with 8 nm diameter cobalt metal nanoparticles. As shown by replacing at least 50% by total metal weight of the platinum with cobalt metal nanoparticles, the current magnitude increase is larger than for the platinum-only electrode ink. Although substituting 30% by total metal weight of the platinum shows the largest current magnitude increase, greater weight fractions of cobalt metal nanoparticles also work well. It is clear in curves B-D that by adding these nanoparticles to the catalyst ink, both oxygen reduction kinetics (shown in Region 1) and mass transport (shown in Region 2) are improved. In other types of fuel cell electrodes, greater than 50% of the platinum can be replaced with the nanoparticles, and preferably up to 95% by total metal loading weight can be replaced with nanoparticles.

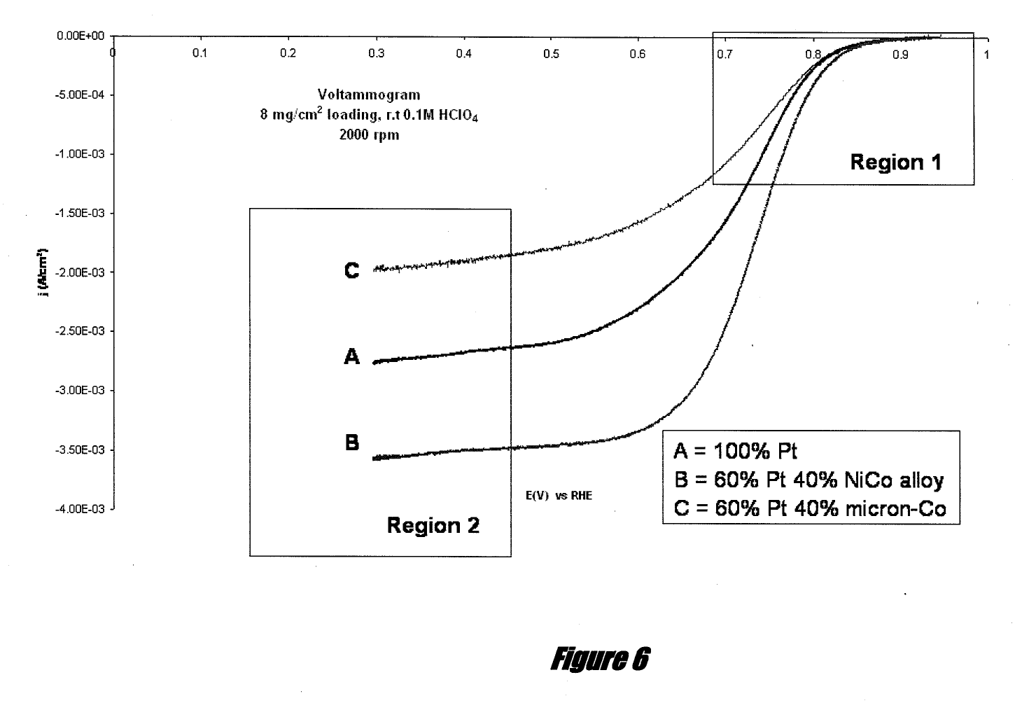

FIG. 6 also shows a liner sweep voltammogram of the cathode fuel cell reaction, showing performance increasing using a metal alloy nanoparticle electrode. Total metal loading was 8 mg/cm² for each sample. It illustrates the improved performance of a 60% platinum 40% nickel-cobalt metal alloy, with average nickel-cobalt metal alloy particle size of 15 nm, electrode (curve B) versus a finely divided platinum electrode (curve A). Similar to the previous example using metal nanoparticles, the current magnitude increases greater with increasing voltage for the metal alloy nanoparticle sample, both in the kinetic activation (Region 1) and mass transfer regimes (Region 2). In addition, a performance inhibiting effect is observed for the electrode containing 60% platinum 40% 800 nm average diameter cobalt particles by weight (curve C).

This data illustrates the importance of using nanoparticles, as particles at or above the micron size observably decrease electrode performance due to the incompatible surface areas of the finely divided platinum, at or less than 100 nm and the micron cobalt, in the 800-1500 nm size range.

Many other nanoparticles when admixed with platinum and made into an electrode ink, also show this performance enhancement. For example, when 10 to 50% by weight of total metal loading of finely divided 50:50 atomic ratio platinum:ruthenium is replaced with 15 nm average diameter chromium metal nanoparticles and are used in an anode electrode ink, catalysis enhancement is observed for methanol oxidation. Preferably, the mixture will contain 50% chromium and 50% platinum:ruthenium by weight, and more preferably the mixture will be at least 70% chromium and 30% platinum:ruthenium by weight. Most preferred is a 85% chromium 15% platinum ruthenium mixture by weight. Total platinum:ruthenium loading can also be reduced at the anode by addition of 10 nm average particle size palladium nanoparticles. Preferably, the mixture will contain 50% platinum:ruthenium and 50% palladium by weight, and more preferably the mixture will be at least 70% palladium and 30% platinum:ruthenium by weight. Most preferred is a 15% platinum:ruthenium 85% palladium mixture by weight. As another example, methanol oxidation rate is enhanced by replacement of 50% by weight of total metal loading of platinum with 80:20 nickel-iron alloy nanoparticles that have an average diameter if 15 nm, preferably, the mixture will be at least 70% nickel-iron alloy nanoparticles and 30% platinum. Most preferably is a 15% platinum 85% chromium mixture by weight. In both of these cases, other nanoparticles and other ratios of metal alloy nanoparticles work sufficiently compared to the reaction of finely divided platinum: ruthenium.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A direct methanol fuel cell comprising a cathode comprising a composition including a plurality of reactive metal or metal alloy nano-particles supported on a conductive substrate, platinum or platinum alloy particles, and an ionomer, wherein at least a portion of the reactive nano-particles comprise an oxide shell.

2. The fuel cell of claim 1, wherein the platinum or platinum alloy particles comprise platinum or platinum alloy nano-particles.

3. The fuel cell of claim 1, wherein the substrate comprises carbon.

4. The fuel cell of claim 3, wherein the substrate comprises one or more of carbon powder, carbon paper, or carbon fabric.

5. The fuel cell of claim 1, wherein the ionomer is less than 40% by weight of the combined weight of the reactive nano-particles and the platinum or platinum alloy particles in the composition.

6. The fuel cell of claim 1, wherein the ionomer comprises a fluorocarbon.

7. The fuel cell of claim 1, wherein at least a substantial portion of the plurality of reactive nano-particles have a diameter of less than about 100 nm.

8. The fuel cell of claim 1, wherein the reactive nano-particles comprise nano-particles having a diameter of less than about 10 nm.

9. The fuel cell of claim 1, wherein the plurality of reactive nano-particles comprises one or more metals selected from the group consisting of metals from groups 3-16 and lanthanides.

10. The fuel cell of claim 9, wherein the plurality of reactive nano-particles comprise one or more transition metals selected from the group consisting of chromium, ruthenium, iron, cobalt, nickel, copper, palladium, silver, and gold.

11. The fuel cell of claim 1, wherein the reactive nano-particles are about 5% or more by weight of the combined weight of the reactive nano-particles and the platinum or platinum alloy particles in the composition.

12. The fuel cell of claim 11, wherein the reactive nano-particles are about 30% of the combined weight of the reactive nano-particles and the platinum or platinum alloy particles in the composition.

13. The fuel cell of claim 11, wherein the reactive nano-particles are between about 50% and 75% by weight of the combined weight of the reactive nano-particles and the platinum or platinum alloy particles in the composition.

14. The fuel cell of claim 11, wherein the reactive nano-particles are about 90% or more by weight of the combined weight of the reactive nano-particles and the platinum or platinum alloy particles in the composition.

15. The fuel cell of claim 1, further comprising a proton-exchange membrane configured to transmit protons to the cathode.
